(19) United States
(12) Patent Application Publication
(10) Pub. No.: US 2022/0234052 A1
(43) Pub. Date: Jul. 28, 2022

(54) CONTINUOUS BIOMASS EXTRACTION SYSTEM AND PROCESS

(71) Applicant: Boulder Creek Technologies, LLC, Arvada, CO (US)

(72) Inventors: Steven E. Bonde, Golden, CO (US); Steve Jaasund, Federal Way, WA (US)

(21) Appl. No.: 17/721,213

(22) Filed: Apr. 14, 2022

Related U.S. Application Data
(63) Continuation-in-part of application No. 17/068,017, filed on Oct. 12, 2020, now Pat. No. 10,974,164.
(60) Provisional application No. 62/913,509, filed on Oct. 10, 2019.

(51) Int. Cl. B03C 3/16; B03C 3/53; B03C 3/014; B01D 47/10

(52) U.S. Cl. CPC B03C 3/16; B01D 47/10; B03C 3/014; B03C 3/53

(57) ABSTRACT

A method for producing valuable organic liquid from a biomass wherein a gas is heated to a predetermined temperature to produce a heated gas. The heated gas is mixed with a biomass to produce an enriched organic vapor and a biomass waste product. The biomass waste product is separated from the enriched organic vapor. The enriched organic vapor is cooled to produce a liquid organic oil and the liquid organic oil is collected. A system for producing the liquid organic oil wherein the system includes a heat source for heating a gas to produce a heated gas and a first separation unit to separate an enriched organic vapor and a biomass waste product. The enriched organic vapor and the biomass waste product are generated from mixing the heated gas and a biomass. The system also includes a wet scrubber for cooling the enriched organic vapor to remove certain compounds from the enriched organic vapor to generate an enriched organic smoke. The organic smoke can be transformed to the liquid organic oil in an electrostatic precipitator.

### STATEMENT REGARDING FEDERALLY SPONSORED RESEARCH OR DEVELOPMENT

Not applicable.

### CROSS-REFERENCE TO RELATED APPLICATIONS

The present application is a continuation-in-part application of U.S. Patent Application having U.S. Ser. No. 17/068,017, filed Oct. 12, 2020, which is a conversion of U.S. Provisional Application having U.S. Ser. No. 62/913,509, filed Oct. 10, 2019, which claims the benefit under 35 U.S.C. 119(e). The disclosure of which is hereby expressly incorporated herein by reference.

### BACKGROUND OF THE DISCLOSURE

### 1. Field of the Invention

The present disclosure relates to methods and systems for extracting and condensing oils and compounds of value from a biomass, including, but not limited to hemp, herbs, and hops. More specifically, this disclosure relates to methods and systems for extracting product from plant material through hot gas vaporization and condensation via electrostatic precipitation. In one exemplary embodiment, those products are cannabinoid rich oils resulting from the hemp plant.

### 2. Background of Invention

These oils and other compounds are used in a wide variety of applications, including as additives in household cleansers and personal care products (e.g. shampoos, lotions, facial cleansers), flavorings, supplements, and pain relief treatments. Examples of plant matter that contains useful oils and valuable compounds include lavender flowers, hops, eucalyptus leaves, peppermint leaves, tea tree leaves, jojoba seeds, rose petals, cannabis flowers, and jasmine flowers. Processes for extracting oils and compounds of value from biomass commonly employ a solvent, such as ethyl alcohol (ethanol), which is highly flammable and facilities are limited in quantities they can store, or supercritical carbon dioxide (CO2), which must be operated at pressures significantly above atmospheric pressure. In addition, the extract produced from these kinds of processes often undergo further post-extraction processes that use harmful or flammable solvents to refine or isolate these compounds.

In addition to extracting desirable plant constituents, commonly employed solvent-based extraction processes may also remove undesirable ballast from the plant material. Ballast may include certain plant constituents such as fats, waxes, carbohydrates, proteins, and sugars. This ballast may alter odor, taste, consistency and/or color of the extract. It may also limit shelf life of the resulting extracts, often resulting in the need for additional processing steps to remove certain forms of ballast from that extract. The current processes for extracting oils and/or compounds of value from biomass can be time-intensive, labor intensive, resource intensive, and/or require multiple pieces of specialized equipment to yield an acceptable product. In addition, these processes only produce limited-size batches of a product rather than a continuous output.

Accordingly, there is a need for a new method and system for efficiently extracting desirable constituents from plant material. More specifically, there is a need for a new extraction method that requires less time, labor, resources, and/or specialized and energy inefficient equipment than existing methods. There is also a need for scalable extraction and condensation methods and apparatus that produces a continuous output of product without requiring a large volume of potentially flammable or hazardous solvent.

### SUMMARY OF THE DISCLOSURE

The present disclosure is related to a method for producing valuable organic liquid from a biomass. A gas is heated to a predetermined temperature to produce a heated gas. The heated gas is mixed with a biomass to produce an enriched organic vapor and a biomass waste product. The biomass waste product is separated from the enriched organic vapor. The enriched organic vapor is cooled to produce a liquid organic oil and the liquid organic oil is collected.

The present disclosure is also directed to a system for producing the liquid organic oil. The system includes a heat source for heating a gas to produce a heated gas and a first separation unit to separate an enriched organic vapor and a biomass waste product. The enriched organic vapor and the biomass waste product are generated from mixing the heated gas and a biomass. The system also includes a wet scrubber for cooling the enriched organic vapor to remove certain compounds from the enriched organic vapor to generate an enriched organic smoke. The organic smoke can be transformed to the liquid organic oil in an electrostatic precipitator.

### BRIEF DESCRIPTION OF THE DRAWINGS

FIG. 1 is a schematic of a continuous biomass extraction system in accordance with the present disclosure.

FIG. 2 is one embodiment of an electrostatic precipitator incorporated in the biomass extraction system in accordance with the present disclosure.

FIG. 3 is an auger apparatus incorporated in the biomass extraction system in accordance with the present disclosure.

FIG. 4 is a schematic of another embodiment of a continuous biomass extraction system in accordance with the present disclosure.

FIG. 5 is a cross-sectional view of another embodiment of an electrostatic precipitator incorporated in the biomass extraction system in accordance with the present disclosure.

FIG. 6 is a schematic of yet another embodiment of a continuous biomass extraction system in accordance with the present disclosure.

FIG. 7 is a cross-sectional view of a cyclonic entry device incorporated in the biomass extraction system in accordance with the present disclosure.

FIGS. 8A and 8B are cross-sectional views of various embodiments of a wet scrubber apparatus incorporated in the biomass extraction system and constructed in accordance with the present disclosure.

### DETAILED DESCRIPTION OF THE DISCLOSURE

A continuous process for extracting oils and/or compounds of value from plant material includes passing the plant material into a heated air or gas stream for a predetermined duration within a predetermined temperature range sufficient to vaporize the essential oils and/or compounds of value of the plant material without causing pyrolysis of the plant material. The vaporized oils and/or compounds of value may be swept from the plant material by a flow of gas and then condensed to liquid form using a unique electrostatic precipitation condenser. The resulting liquid may then be distilled to isolate certain desirable compounds as preferred. The method described herein may enable useful separation of certain desirable plant constituents, which are not volatile at ambient temperatures, to be extracted upon exposure to a predetermined temperature for a predetermined duration. The method allows for extraction of oils and botanical compounds without requiring a solvent and without operating the system at pressures significantly above atmospheric pressure. The system disclosed herein can continuously be fed the plant material and continuously produce oils and botanical compounds and does not require the production to be performed in batches.

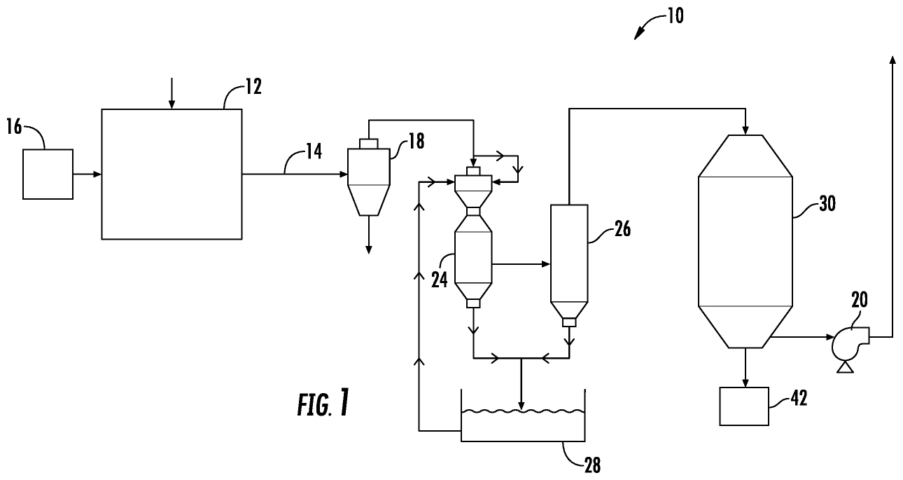

The present disclosure relates to an extraction system 10, such as that shown in FIG. 1, for collecting a valuable organic extract from a biomass, such as hemp, herbs or hops, and a method for collecting a valuable organic extract from a biomass, such as hemp, herbs or hops. The extraction system 10 can include a biomass introduction unit 12 for providing the biomass to the system 10. The introduction unit 12 can include an auger for receiving and transporting ground biomass to a receiver, which is used to break up and direct the biomass toward a rotary seal connected to a first conduit 14 that connects a heat source 16 and a first separation unit 18. A gas, such as air or inert gas, is heated by the heat source 16 to be mixed with the biomass in the first conduit 14. The heated gas subjects the biomass to flash extraction and causes an enriched organic vapor to be created, thus vaporization of a portion of the biomass occurs in the first conduit 14.

A blower 20 can be attached to the tail end of the system 10 to provide a sufficient vacuum draw to the system 10 to keep the system 10 under negative pressure, thus allowing the biomass and resulting vapors to be pulled towards the end of the system 10. Alternatively, a blower 20 could be attached to the front end of the system 10 to create a positive pressure environment and push biomass and vapors through the system 10. In either embodiment, the air or inert gas flows through the heat source 16 where it reaches the process temperature, which is between 150° C. and 400° C. and can proceed into the first conduit 14 where the vaporization occurs. As the ground biomass is swept through the first conduit 14, the compounds of interest are vaporized into the airstream to form a dilute mixture of air/inert gas. The mixture of air/inert gas, oil vapors, and depleted biomass exit the first conduit 14 and are passed into the first separation unit 18, such as a cyclone separator that is used to separate the solid biomass from the enriched organic vapor. It should be understood and appreciated that the first separation unit 18 can be any apparatus known in the art capable of separating a solid (spent biomass) and gas (mixture of organic vapor and air/inert gas).

The portion of the first conduit 14 between where the heated gas and the biomass are combined and the first separation unit 18 can be sized (length and diameter) such that a requisite amount of enriched organic vapor is produced. Furthermore, the flowrate and temperature of the heated gas and the biomass in the first conduit 14 can be adjusted to make sure the requisite amount of enriched organic vapor is produced. The first conduit 14 can include multiple sections where the diameter is increased and/or decreased to create turbulent flow of the heated gas and the biomass as they are passed through the first conduit 14 and to the first separation unit 14.

The heated gas must be hot enough to allow the vapor pressure to become high enough that the enriched organic vapor will be suspended in the heated gas flowing through the first conduit 14. In one embodiment, the biomass and gas are heated to a temperature between about 100° C. and about 400° C. In another embodiment, the biomass and gas are heated to a temperature between about 175° C. and about 325° C. In a further embodiment of the present disclosure, the biomass and gas are heated to a temperature between about 165° C. and about 275° C.

The enriched organic vapor is separated from the biomass in the first separation unit 18 to create a biomass waste, which can be taken and sold or used to produce various other products. The first separation unit 18 can be any device capable of separating a solid material from a gaseous material. In one embodiment, the first separation unit 18 can be a cyclone that spins and forces the solid material outward in the cyclone and the gaseous material can generally be pulled from the top of the cyclone.

The enriched organic vapor, which contains water, air, terpenes, flavonoids, alkaloids, fatty acids, etc., is then sent to a wet scrubber 24 where the enriched organic vapor can be cooled to the natural adiabatic wet bulb temperature of the gas stream. In another example, the water in the wet scrubber 24 may be cooled to between 4° C. and 25° C. When the enriched organic vapor is cooled, the water vapor, terpenes and other vapor phase compounds disposed therein condense into liquid droplets. Some of these small droplets may be captured in the water used in the wet scrubber 24. The small droplets captured in the water of the wet scrubber 24 can be recycled back to the system 10, sent to a water bath 28 or separated into separate compounds and used for other purposes. The remaining particles of the enriched organic vapor, referred to as an organic smoke, will be pulled or pushed into a second separation unit 26 where entrained liquid droplets from the wet scrubber 24 and any dust particles still present are removed. Some of the organic liquid particles that may still be present are also removed in the second separation unit 26. This mixture of water droplets from the wet scrubber 24 plus some portion of the still present organic liquid particles are collected and sent to the water bath 28. In one embodiment, the second separation unit 26 is a cyclonic mist separator that spins the liquid entering and forces the liquid to the outer walls and permits the organic smoke, or cannabinoid particles if the biomass is hemp or cannabis, to pass to an electrostatic precipitator 30.

The organic smoke that leaves the second separation unit 26 and enters the electrostatic precipitator 30 are in the form of sub-micron droplets like a smoke or a fog. Water droplets that have escaped from the second separation unit 26 will be entrained with the organic smoke. These ultra-fine particles and fine water droplets need to be removed to be able to provide an organic oil. The electrostatic precipitator 30 can be any type of electrostatic precipitator known to one of ordinary skill in the art.

In one embodiment, the electrostatic precipitator 30 includes a tube 32 or array of tubes 32 disposed in a parallel arrangement. The tubes 32 may be round, square or hexagonal. Each tube 32 includes a discharge electrode 34 that is centrally located within each tube 32. The centrally located discharge electrode 34 is energized with unipolar high voltage to establish a strong electric field in the inner-electrode spacing between the discharge electrode 34 and an inner surface 36 of the tube 32 which must be electrically connect to ground. The electric field thus established must be strong enough to establish a stable corona discharge between the centrally located discharge electrode 34 and the inner surface 36 of the tube 32. The electrostatic precipitator also includes an inlet 38 for feeding the ultra-fine particles and fine water droplets to the electrostatic precipitator. The electrostatic precipitator 30 can also include an exhaust for expelling any vapor present in the electrostatic precipitator 30 from the electrostatic precipitator 30.

When the organic smoke and the entrained water droplets flow into the electric field the organic smoke particles and droplets become charged when they pass by the high voltage corona and are driven by the electric field to the inner surface 36 the tube 32. This organic liquid (or organic oil) will then drain by gravity into the bottom of the electrostatic precipitator 30 and be directed toward and outlet 39 where the organic oil can be captured.

The voltage of the electrodes needs to be high to accomplish the stated goal. The voltage can be between 10,000 volts to about 50,000 volts. In one embodiment, the discharge electrode can be negatively charged. In another embodiment, the discharge electrode can be positively charged.

The gas stream containing the organic smoke flowing through the inter-electrode zone of the electrostatic precipitator 30 can vary in velocity. In one embodiment, the velocity of the gas stream through the electrostatic precipitator 30 is low enough so that the flow of the gas stream is laminar in nature. Laminar flow occurs when the Reynolds number is less than 2000. In other embodiments the velocity of the gas stream flowing through the inner-electrode zone may be turbulent with a Reynolds number greater than 2000.

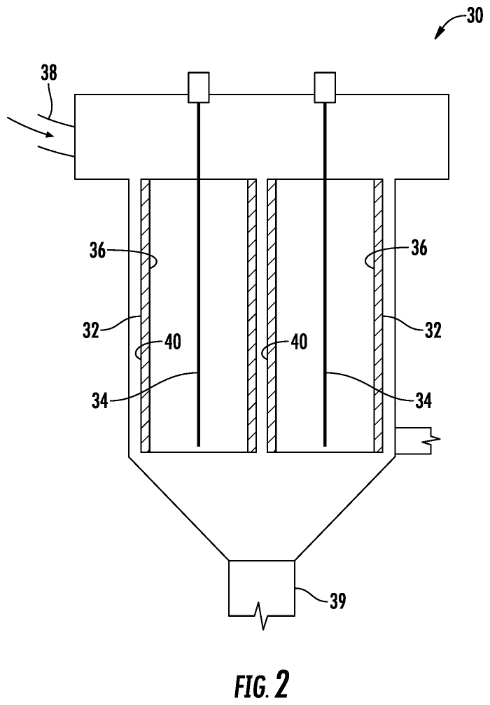

In another embodiment of the present disclosure shown in more detail in FIG. 2, the electrostatic precipitator 30 utilizes round tubes 32. The tubes 32 may be heated on an exterior surface 40 of the tubes 32 to encourage the flow of collected organic liquids on the inner surface 36 of the tube 32. The source of the heat may include a heated liquid such as hot water, thermal oil, pre-heated air or even electric resistance surface heaters.

In yet another embodiment, the organic oil will flow from the inner surfaces 36 of the tubes down into the water bath 28, wherein the organic oil will separate from and drop to the bottom of the water bath 28. In another embodiment, the organic oil exiting the electrostatic precipitator 30 can be sent to a separate collection vessel 42 from the water bath 30 that collected the condensate from the organic enriched vapor in previous steps. Similar to how the organic oil is recovered from the water bath 28, the organic oil can be removed from the bottom of the aqueous portion of the fluid in the separate collection vessel 42 dedicated to the fluid collected from the electrostatic precipitator 30.

In another embodiment of the present disclosure, the fluid in the water bath 30 can be recycled to the scrubber 24 to try and produce additional organic oil to be sent to the second separation unit 26.

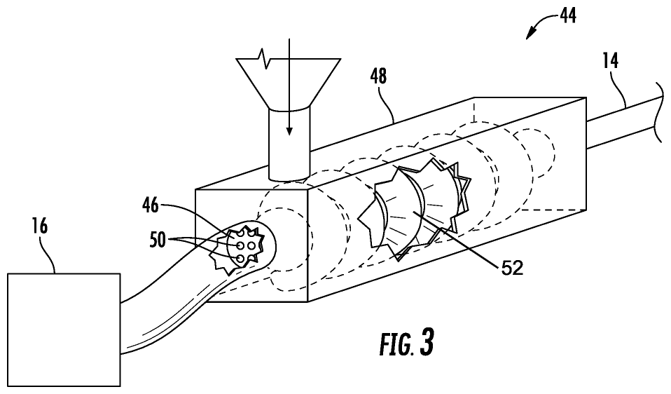

In yet another embodiment of the present disclosure shown in more detail in FIG. 3, the biomass introduction unit 12 can direct the biomass to an auger apparatus 44. The auger apparatus 44 that can have a perforated portion 46 wherein at least a portion of the auger apparatus 44 is porous or perforated to permit the heated gas to flow directly into and through the auger apparatus 44 to heat the biomass in an auger chamber 48 of the auger apparatus 44. The porous portion 46 can be any structural portion of the auger apparatus 44 such as the walls, the top portion or the bottom portion. The porous portion 46 has openings 50 therein that are sized to permit the heated gas to flow through but would prevent the biomass from passing through. The flow rate of the heated gas through the openings 50 in the porous portion 46 would also contribute to preventing the biomass from passing through. The auger apparatus 44 would also include an auger 52 for driving the biomass through and out of the auger apparatus 44. In this embodiment, the auger apparatus 44 is in fluid communication with the heat source 16 and the heated gas flows from the heat source 16 to and through the auger apparatus 44. The solid biomass and generated enriched organic vapor then flow into the first conduit 14 that carries the biomass and the enriched organic vapor (cannabinoid enriched vapor in certain embodiments) to the first separation unit 18.

In a further embodiment of the disclosure, a fluidized bed contactor may be used to heat the biomass. Heated air is passed through a fine screen disposed on a bottom portion of the fluidized bed which allows the heated air to pass upward through the fine screen and tumble the ground biomass. The enriched organic vapors created from heating the biomass on the fluidized bed contactor can then be passed to the first separation unit 18 of the system 10.

The system and method described herein can yield certain results with respect to the compounds of value in the biomass. In an exemplary embodiment of the present disclosure, where the compound of value is cannabidiol (CBD) and the biomass is hemp and/or cannabis, a certain amount of the CBD can be recovered at various stages in the method and system. The amount of CBD in the biomass can be determined prior to passing into the system described herein. In one embodiment, the weight percent of CBD recovered after the biomass and the heated gas has been mixed and separated is greater than 40 percent. In another embodiment, the weight percent of CBD recovered after the biomass and the heated gas has been mixed and separated is greater than 65 percent. In a further embodiment, the weight percent of CBD recovered after the biomass and the heated gas has been mixed and separated is greater than 75 percent.

Further to the exemplary embodiment herein, the resulting valuable organic oil produced by the described system and method is primarily CBD oil and the system and method disclosed herein can produce a primarily CBD oil and has a certain potency. The CBD potency of the organic oil is the weight percent that CBD is of the total weight of the organic oil. In one embodiment, the CBD weight percent of the weight of the organic oil produced is greater than 70 percent. In another embodiment, the CBD weight percent of the weight of the organic oil produced is greater than 80 percent.

The amount of CBD in the biomass introduced to the system can be compared to the amount of CBD in the organic oil captured by the system. In one embodiment, the weight percent of CBD captured in the organic oil is greater than 30 percent of the total weight of the CBD in the biomass prior to being introduced to the system. In another embodiment, the weight percent of CBD captured in the organic oil is greater than 40 percent of the total weight of the CBD in the biomass prior to being introduced to the system.

Furthermore, the amount of CBD in the enriched organic vapor (the vapor created by mixing the heated gas and the biomass) can be evaluated versus the amount of CBD in the organic oil produced by the system. In one embodiment, the weight percent of the CBD contained in the organic oil is greater than 40 percent of the weight of the CBD contained in the enriched organic vapor entering the first separation unit or exiting the first separation unit. In another embodiment, the weight percent of the CBD contained in the organic oil is greater than 50 percent of the weight of the CBD contained in the enriched organic vapor entering the first separation unit or exiting the first separation unit.

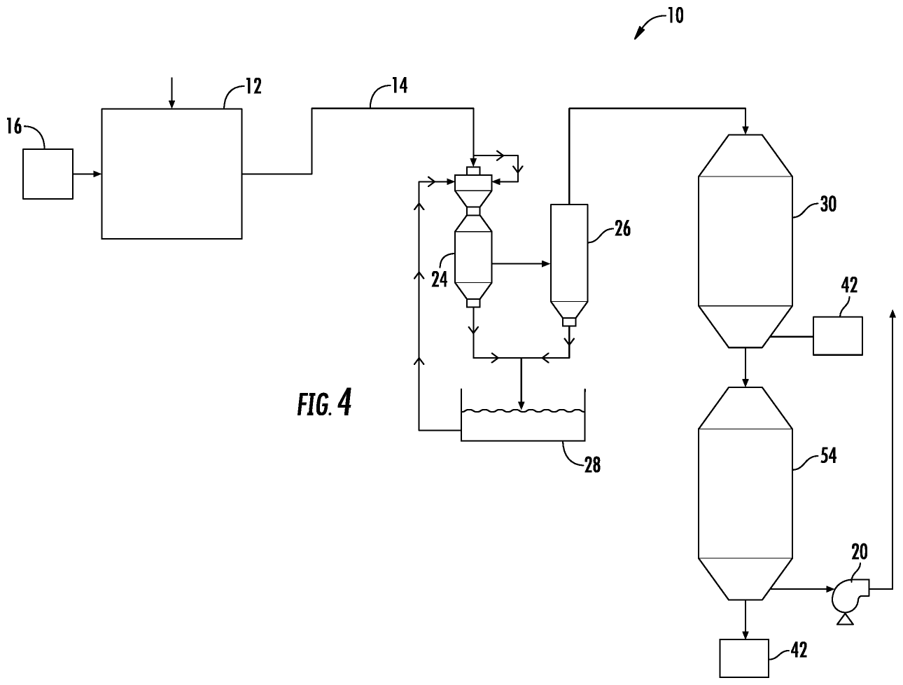

In a further embodiment of the present disclosure shown in more detail in FIG. 4, the extraction system 10 does not include the first separation unit 18 and the wet scrubber 24 receives the enriched organic vapor and the biomass from the first conduit 14. In this embodiment, the wet scrubber removes the biomass from the enriched organic vapor and provides the cooling necessary cool the enriched organic vapor to the natural adiabatic wet bulb temperature of the gas stream. When the enriched organic vapor is cooled in the wet scrubber 24, the water vapor, terpenes and other vapor phase compounds disposed therein condense into liquid droplets. The biomass and some of these liquid droplets may be captured in the water used in the wet scrubber 24. The biomass, liquid droplets and the water from the wet scrubber 24 can be sent to a centrifuge (not shown) to separate the liquid components (water and liquid droplets) from the biomass. The biomass can be dealt with as previously described herein and the water and liquid droplets can be recycled back to the wet scrubber 24, or alternatively, the water and liquid droplets can be fed to the water bath 28 before recycling them back to the wet scrubber 24. Similarly to the extraction system 10 described in FIG. 1, the remaining particles of the enriched organic vapor, referred to as the organic smoke, will be pulled or pushed into the second separation unit 26 where entrained liquid droplets from the wet scrubber 24 and any dust particles still present are removed.

In another embodiment, the extraction system 10, as described in any embodiment herein, can include a second electrostatic precipitator 54, disposed in the extraction system 10 before or after the first electrostatic precipitator 30, operated at a lower temperature than the electrostatic precipitator 30 to capture compounds with lower boiling points, such as terpenes, flavonoids, etc. The second electrostatic precipitator 54 is shown in FIG. 4, but it could be used in the extraction system 10 shown in FIG. 1 as well. The typical operating temperature of the electrostatic precipitator 30 is in the range of 55 degrees Celsius to about 98 degrees Celsius. The operating temperature of the second electrostatic precipitator 54 is about 0 degrees Celsius to about 50 degrees Celsius. To create the lower operating temperature of the second electrostatic precipitator 54, it can be chilled via cool air or water pumped through a jacket that surrounds the second electrostatic precipitator 54. Similarly, the electrostatic precipitator 30 can be warmed via a heat jacket disposed outside of the tubes 32 to encourage the flow of collected liquid from the tubes 32. The heat jacket can be supplied with warm air or liquid to provide the heat to increase the operating temperature of the electrostatic precipitator 30. The organic oil exiting the electrostatic precipitator 54 can be sent to a separate collection vessel 55.

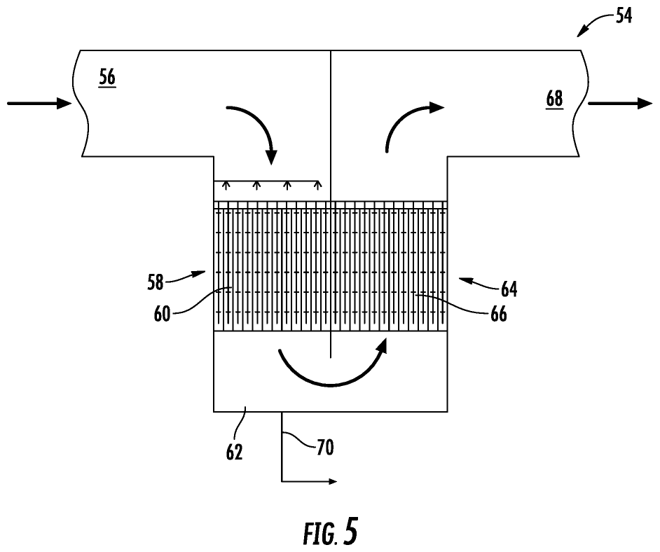

In a further embodiment, the electrostatic precipitator 30 or 54 can be a downflow/upflow type of electrostatic precipitator as shown in more detail in FIG. 5. In this embodiment, the electrostatic precipitator 30 or 54 will include a smoke inlet 56 where the organic smoke from the second separation unit (or whatever apparatus is disposed upstream from the electrostatic precipitator 30 or 54) can feed into a downflow portion 58 of the electrostatic precipitator 54. The downflow portion 58 includes a first energized section 60 that the organic smoke and the entrained water droplets flow into and through. After passing through the first energized section 60, any remaining organic smoke and entrained water droplets will pass into a plenum 62 that directs the organic smoke and the entrained water droplets upward into an upflow portion 64 of the electrostatic precipitator 30 or 54. The upflow portion 64 includes a second energized section 66 that the organic smoke and the entrained water droplets will flow into and through. After passing through the second energized section 66, any remaining portions of the organic smoke and the entrained water droplets will exit the electrostatic precipitator 30 or 54 via a smoke outlet 68. The organic smoke and the entrained water droplets that exit the electrostatic precipitator 30 or 54 via the smoke outlet can be recycled back to the electrostatic precipitator 30 or 54.

The organic smoke particles and droplets become charged when they pass into the first energized section 60, which causes some of the organic smoke and the entrained water droplets to convert to the organic liquid that can drain down to the plenum 62. Similarly, the organic smoke particles and droplets that pass into the upflow portion 64 become charged when they pass into the second energized section 66, which causes some of the organic smoke and the entrained water droplets to convert to the organic liquid that can drain down to the plenum 62. The organic liquid that is generated in the first and second energized sections 60 and 66 and collected in the plenum 62 can be withdrawn from the electrostatic precipitator 30 or 54 via a liquid outlet 70 disposed in the plenum 62 of the electrostatic precipitator 30 or 54. It should be understood and appreciated that the electrostatic precipitator 30 or 54 can include any other operational aspects known in the art for electrostatic precipitators.

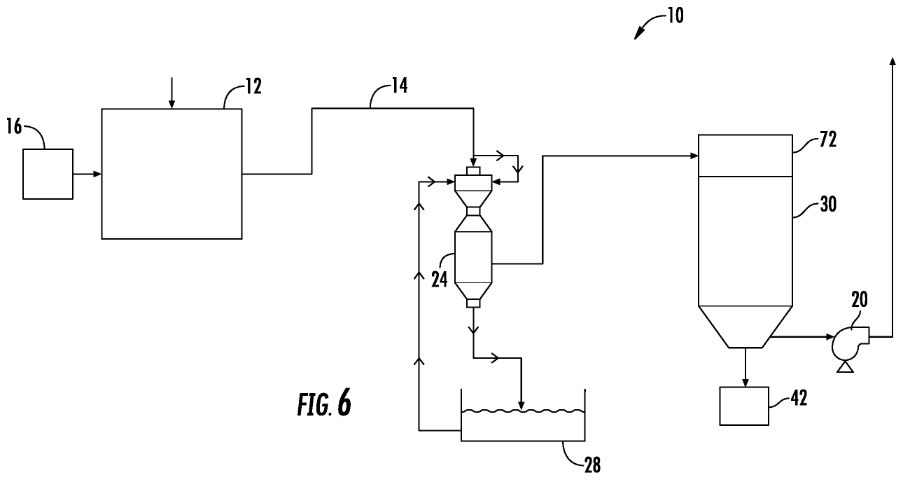

Referring now to FIG. 6, shown therein is another embodiment of the extraction system 10. In this embodiment, the extraction system 10 is similar to the extraction system 10 shown in FIG. 4, but with the second separation unit 26 removed and a cyclonic entry device 72 for removing any entrained liquid droplets picked up in the wet scrubber 24 from the enriched organic vapor (or organic smoke) and distribute the enriched organic vapor into the electrostatic precipitator 30. The cyclonic entry device 72 is disposed on, or immediately above, the electrostatic precipitator 30. The cyclonic entry device 72 can also be sized such that its diameter is substantially the same diameter as the electrostatic precipitator 30. Furthermore, the cyclonic entry device 72 is also designed to expand and reduce the speed of the enriched organic vapor as it enters the electrostatic precipitator 30.

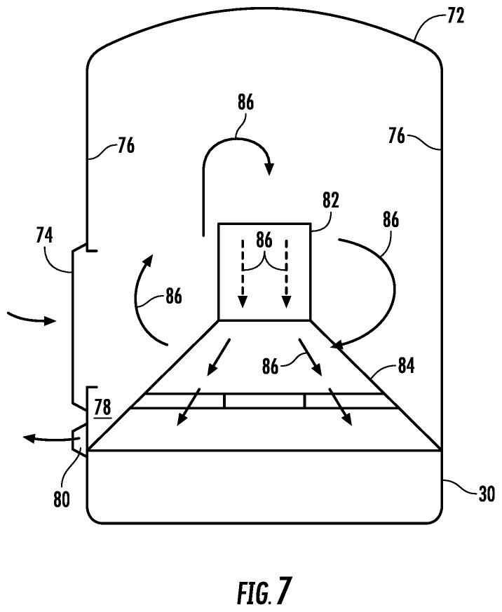

Referring now to FIG. 7, shown therein is one embodiment of the cyclonic entry device 72. The cyclonic entry device 72 can include an inlet 74 for receiving the enriched organic vapor (or enriched organic smoke) and entrained liquid droplets from the scrubber 24. The inlet 74 can be disposed such that the enriched organic vapor and entrained liquid droplets enter tangentially to an outer wall 76 of the cyclonic entry device 72. The tangential entry of the enriched organic vapor and entrained liquid droplets causes a vortical flow (or cyclonic spin) of the enriched organic vapor and entrained liquid droplets inside the cyclonic entry device 72, which causes the entrained liquid droplets to be forced to the outer wall 76 of the cyclonic entry device 72. The entrained liquid droplets can then collect at a bottom portion 78 of the cyclonic entry device 72 where the collected entrained liquid droplets can be removed from the cyclonic entry device 72 via a liquid outlet 80. The enriched organic vapor will be spun up as well and migrate vertically upward and then pass downward through a centrally located and vertically disposed duct 82. After passing downward through the duct 82, the enriched organic vapor can enter a cone 84 where the velocity of the enriched organic vapor is reduced and spread radially before entering the electrostatic precipitator 30 or 54. In one embodiment, the outer diameter of the cone 84 at its widest point is generally the same size as the cross-sectional size of the operable area of the electrostatic precipitator 30 or the operable area of the downhole part of the electrostatic precipitator 54. The hot enriched organic vapor in the cyclonic entry device 72 disposed on the top of the electrostatic precipitator 30 or 54 creates a heated apparatus above the electrostatic precipitator 30 or 54, which eliminates the requirement to insulate an entry section of the electrostatic precipitator 30 or 54. The arrows 86 help show the flow of the enriched organic vapor and entrained liquid droplets in the cyclonic entry device 72.

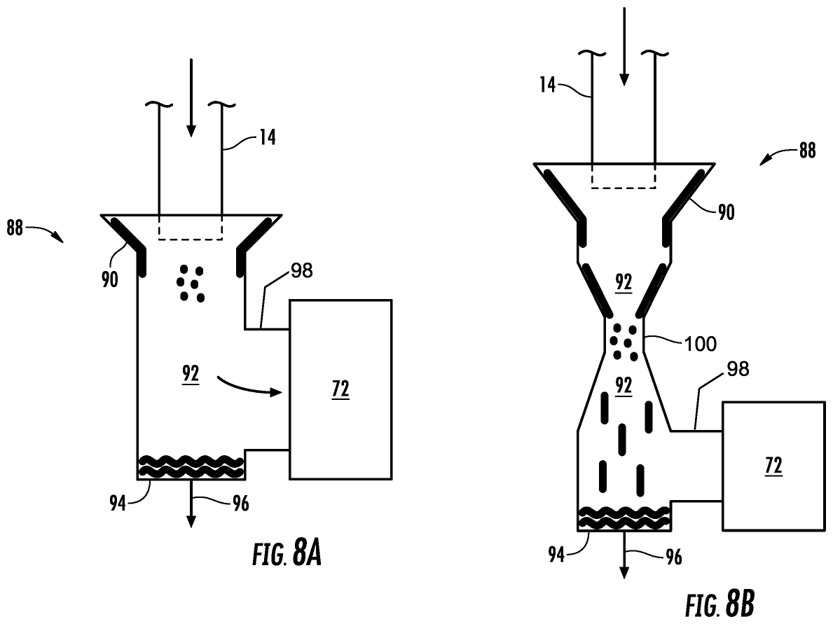

The wet scrubber 24 can be any type of wet scrubber known in the art for separating desired components of a stream of materials. Referring now to FIG. 8A, shown therein is a wet scrubber apparatus 88 (can be used in place of the wet scrubber 24 described herein) for accepting the enriched organic vapor and the biomass from the first conduit 14. In this embodiment, the first conduit 14 is downwardly disposed and distributes the enriched organic vapor and the biomass from downward into the wet scrubber apparatus 88. The wet scrubber apparatus 88 includes a conical apparatus 90 that can be wetted by injecting into multiple places on the conical apparatus 90 and tangentially to the conical apparatus 90. In one embodiment, the first conduit 14 distributes the enriched organic vapor and the biomass between the top part of the conical apparatus 90 and a bottom part of the conical apparatus 90. The water and the enriched organic vapor and the biomass from the first conduit 14 will mix and proceed downward into a body portion 92 of the wet scrubber apparatus 88. The water in the mixture of the water and the enriched organic vapor and the biomass can capture the biomass. A majority of the water and biomass will be captured in a flooded elbow 94 disposed on a lower part of the body portion 92 of the wet scrubber apparatus 88. The biomass and water can be removed from the wet scrubber apparatus 88 via a liquid outlet 96 disposed in the flooded elbow 94 of the wet scrubber apparatus 88. The water and biomass from the liquid outlet can be sent to a centrifuge wherein the water can be recycled back to the wet scrubber apparatus 88. The enriched organic vapor and any liquid droplets encapsulated therein are forced to a horizontally disposed outlet 98 where they can be fed to the cyclonic entry device 72 in certain embodiments. In a further embodiment shown in FIG. 8B, the body portion 92 of the wet scrubber apparatus 88 can include a venturi section 100 to increase the speed of the enriched organic vapor, water and the biomass to create a more turbulent flow, which increases the amount of biomass captured by the water.

From the above description, it is clear that the present disclosure is well-adapted to carry out the objectives and to attain the advantages mentioned herein, as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A method for producing valuable organic liquid from a biomass, the method comprising:
heating a gas to a predetermined temperature to produce a heated gas;
mixing a biomass with the heated gas to produce an enriched organic vapor and a biomass waste product;
separating the enriched organic vapor from the biomass waste product and cooling the enriched organic vapor in a wet scrubber to remove certain compounds from the enriched organic vapor to produce an enriched organic smoke;
transforming the enriched organic smoke to a liquid organic oil; and
collecting the liquid organic oil.

2. The method of claim 1 wherein the wet scrubber includes:
a conical apparatus with water injected tangentially into the conical apparatus;
a body portion extending downward from a lower part of the conical apparatus wherein the water injected into the conical apparatus is mixed with the enriched organic vapor and the biomass waste product;
a flooded elbow disposed below the body portion for collecting the water and the biomass waste product; and
a horizontally disposed gas outlet for distributing the enriched organic smoke to a downstream apparatus.

3. The method of claim 1 wherein the step of separating the enriched organic vapor from the biomass waste product occurs in a first cyclonic separation unit and the enriched organic vapor is then sent to the wet scrubber.

4. The method of claim 3 further comprising the step of collecting a portion of the liquid organic oil from the enriched organic vapor with a first electrostatic precipitator.

5. The method of claim 4 wherein the first electrostatic precipitator is warmed to a certain temperature via circulating warm air or liquid around parts of the first electrostatic precipitator.

6. The method of claim 4 further comprising the step of passing the enriched organic vapor escaping the first electrostatic precipitator to a second electrostatic precipitator.

7. The method of claim 6 wherein the second electrostatic precipitator is cooled to a certain temperature via circulating cold air or liquid around parts of the second electrostatic precipitator.

8. The method of claim 4 wherein the first electrostatic precipitator is an upflow/downflow electrostatic precipitator comprising:
a downhole part that accepts the enriched organic vapor via a smoke inlet;
a first energized section disposed in the downhole part to cause the liquid organic oil to be collected from the enriched organic vapor;
a plenum to direct the enriched organic vapor from the downhole part upward to an uphole part;
a second energized section disposed in the uphole part to cause additional liquid organic oil to be formed from the enriched organic vapor that passes into the second energized section, the organic oil generated in the downhole part and the uphole part collects in the plenum and is collected therefrom via a liquid outlet.

9. The method of claim 1 further comprising a cyclonic entry device to remove liquid droplets contained in the enriched organic smoke prior to distributing the rich organic smoke to an electrostatic precipitator, the cyclonic entry device includes:
an inlet for receiving the enriched organic smoke and liquid droplets contained therein, the inlet disposed such that the enriched organic smoke and liquid droplets are distributed tangentially to an outer wall of the cyclonic entry device;
a duct centrally and vertically disposed in the cyclonic entry device to receive the enriched organic smoke separated from the liquid droplets that are forced toward the outer wall and down to a liquid outlet; and
a cone attached to the duct to slow and spread the enriched organic smoke in a radial direction as the enriched organic smoke travels into the electrostatic precipitator.

10. The method of claim 9 wherein the cyclonic entry device is disposed directly on top of the electrostatic precipitator.

11. A system for producing valuable organic liquid from a biomass, the system comprising:
a heat source for heating a gas to produce a heated gas;
a wet scrubber for to separate an enriched organic vapor and a biomass waste product, the enriched organic vapor and biomass waste product generated from mixing the heated gas and a biomass, the wet scrubber cooling the enriched organic vapor to remove certain compounds from the enriched organic vapor to generate an enriched organic smoke; and
a first electrostatic precipitator for transforming the enriched organic smoke to a liquid organic oil.

12. The system of claim 11 further comprising a cyclonic mist to separate entrained liquid droplets and biomass dust particles exiting the wet scrubber from the enriched organic smoke.

13. The system of claim 11 wherein the wet scrubber includes:
a conical apparatus with water injected tangentially into the conical apparatus;
a body portion extending downward from a lower part of the conical apparatus wherein the water injected into the conical apparatus is mixed with the enriched organic vapor and the biomass waste product;
a flooded elbow disposed below the body portion for collecting the water and the biomass waste product; and
a horizontally disposed gas outlet for distributing the enriched organic smoke to a downstream apparatus.

14. The system of claim 12 further comprising a first cyclonic separation unit to further separate the biomass and the enriched organic vapor.

15. The system of claim 11 wherein the first electrostatic precipitator is warmed to a certain temperature via circulating warm air or liquid around parts of the first electrostatic precipitator.

16. The system of claim 11 further comprising a second electrostatic precipitator for receiving the enriched organic vapor escaping the first electrostatic precipitator.

17. The system of claim 16 wherein the second electrostatic precipitator is cooled to a certain temperature via circulating cold air or liquid around parts of the second electrostatic precipitator.

18. The system of claim 11 wherein the first electrostatic precipitator is an upflow/downflow electrostatic precipitator comprising:
a downhole part that accepts the enriched organic vapor via a smoke inlet;
a first energized section disposed in the downhole part to cause the liquid organic oil to be collected from the enriched organic vapor;
a plenum to direct the enriched organic vapor from the downhole part upward to an uphole part;
a second energized section disposed in the uphole part to cause additional liquid organic oil to be formed from the enriched organic vapor that passes into the second energized section, the organic oil generated in the downhole part and the uphole part collects in the plenum and is collected therefrom via a liquid outlet.

19. The system of claim 11 further comprising a cyclonic entry device to remove liquid droplets contained in the enriched organic smoke prior to distributing the rich organic smoke to an electrostatic precipitator, the cyclonic entry device includes:
an inlet for receiving the enriched organic smoke and liquid droplets contained therein, the inlet disposed such that the enriched organic smoke and liquid droplets are distributed tangentially to an outer wall of the cyclonic entry device;
a duct centrally and vertically disposed in the cyclonic entry device to receive the enriched organic smoke separated from the liquid droplets that are forced toward the outer wall and down to a liquid outlet; and
a cone attached to the duct to slow and spread the enriched organic smoke in a radial direction as the enriched organic smoke travels into the electrostatic precipitator.

20. The system of claim 19 wherein the cyclonic entry device is disposed directly on top of the electrostatic precipitator.
